(19) United States
(12) Patent Application Publication
(10) Pub. No.: US 2016/0036848 A1
(43) Pub. Date: Feb. 4, 2016

(54) INTERCLOUD SECURITY AS A SERVICE

(71) Applicant: Cisco Technology, Inc., San Jose, CA (US)

(72) Inventors: TIRUMALESAR REDDY, Bangalore (IN); PRASHANTH PATIL, Karnataka (IN); SANDEEP RAO, Bangalore (IN)

(21) Appl. No.: 14/484,127

(22) Filed: Sep. 11, 2014

(30) Foreign Application Priority Data
Jul. 31, 2014 (IN) 817/KOL/2014

(51) Int. Cl. H04L 29/06; H04L 29/08; H04L 29/12

(52) U.S. Cl. CPC H04L 63/1441; H04L 61/1511; H04L 67/02

(57) ABSTRACT

In an approach, a cloud connector component acts as a broker between a client computer, a security-enhanced domain name server, and a content scanning server. When receiving a domain name service (DNS) request from a client computer, the cloud connector forwards the DNS request to the security-enhanced domain name server. The security-enhanced domain name server performs a DNS lookup on a URL contained within the DNS request to determine a network address for a corresponding content provider. In addition, the security-enhanced domain name server calculates a reputation score for the content provider and determines whether the content provider is trustworthy based on the reputation score. The security-enhanced domain name server then sends a DNS response back to the cloud connector that specifies the network address and the result of the trustworthy determination. If the content provider is trustworthiness, the cloud connector forwards the DNS response to the client computer. The client computer then sends a content request to the content provider and receives back the requested content. However, if the content provider is not trustworthy, the DNS response is modified to specify the network address of the content scanning server. As a result, the client computer sends the content request to the content scanning server which then proxies the request to the content provider. The content scanning server monitors the traffic passing back and forth between the client computer and the content provider for malware and other potential dangers.

### BENEFIT CLAIM

This application claims the benefit under 35 U.S.C. 119 of India application 817/KOL/2014, filed Jul. 31, 2014, the entire contents of which are hereby incorporated by reference for all purposes as if fully set forth herein.

### FIELD OF THE DISCLOSURE

The present disclosure generally relates to techniques for providing security services. The disclosure relates more specifically to techniques for redirecting traffic to a suspicious content provider through a content scanning service.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Security as a Service (SECaaS) is a model in which a large service provider integrates their security services into a corporate infrastructure on a subscriber basis more cost effectively than most individuals or corporations could provide on their own. In this scenario, security is delivered as a service from the cloud without requiring on-premises hardware, thus avoiding substantial capital outlays. Security services provided often include authentication, anti-virus, anti-malware/spyware, intrusion detection, security event management, content scanning, domain name resolution, and so forth.

The Domain Name System (DNS) is a hierarchical distributed naming system for computers, services, or any resource connected to the internet or private networks. Most prominently, the DNS translates easily memorized domain names to the network addresses needed for locating computer services and devices around the world. As an analogy, the DNS serves as a phone book for the internet by translating human-friendly computer hostnames into network addresses, such as Internet Protocol (IP) addresses. DNS services often distribute the responsibility of assigning domain names and mapping those names to IP addresses by designating authoritative name servers for each domain. However, traditional DNS is vulnerable to a host of security attacks, such as DNS cache poisoning, in which data is distributed to caching resolvers under the pretense of being an authoritative origin server, thereby polluting the data store with potentially false information and long expiration times. As such, DNS services with added security features have been introduced to mitigate the potential security breaches. As one example, Domain Name Service Security Extensions (DNSSEC) is a specification that extends traditional DNS to add features such as misspelling correction, phishing protection, content filtering, and so forth. In order to gain access to security enhanced DNS, many companies subscribe to SECaaS models that offload DNS services to a well-equipped service provider.

As more and more security services are being offered in the cloud, it has become a challenge to efficiently orchestrate multiple services simultaneously. In traditional SECaaS systems, each service is implemented in an independent and discrete manner, such that each service is its own “black box”. However, in some cases, it may be possible for one service to lavage another service in order to increase the efficiency of the overall system. Content scanning services, for example, are often very resource intensive and cause significant lag when monitoring traffic to and from a client device. For applications which can only tolerate minimal delays, such as video streaming or voice-over-IP services, the delay due to content scanning may render the application completely unusable. However, enterprise businesses cannot simply allow such services unfettered access to their client devices without risking malicious content, such as viruses, trojans, malware, adware, ransomware, and so forth, slipping through to infect their network. As a result, there is a need for a technique to optimize the efficiency of content scanning services while still providing adequate protection against potential threats.

### SUMMARY

The appended claims may serve as a summary of the invention.

### BRIEF DESCRIPTION OF THE DRAWINGS

In the drawings:

FIG. 1 illustrates an operating environment upon which an embodiment may be implemented.

FIG. 2 illustrates an example message flow for redirecting suspicious traffic through a content scanning service according to an embodiment.

FIG. 3 illustrates an example message flow for bypassing a content scanning service for safe traffic according to an embodiment.

FIG. 4 illustrates a computer system with which an implementation may be used.

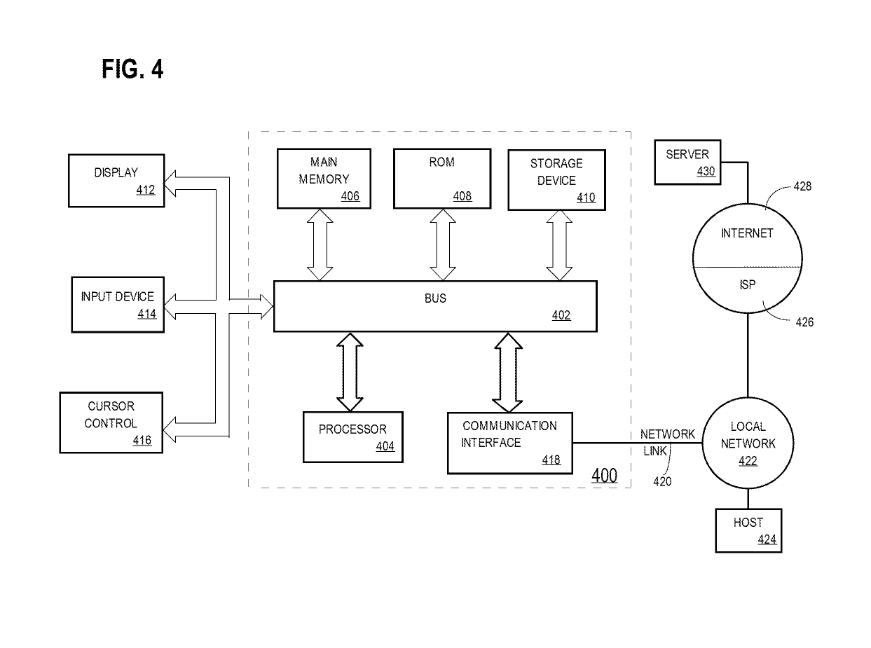

### DETAILED DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1. Overview

In an approach, a cloud connector component acts as a broker between a client computer, a security-enhanced domain name server, and a content scanning server. When receiving a domain name service (DNS) request from a client computer, the cloud connector forwards the DNS request to the security-enhanced domain name server. The security-enhanced domain name server performs a DNS lookup on a URL contained within the DNS request to determine a network address for a corresponding content provider. In addition, the security-enhanced domain name server calculates a reputation score for the content provider and determines whether the content provider is trustworthy based on the reputation score. The security-enhanced domain name server then sends a DNS response back to the cloud connector that specifies the network address and the result of the trustworthiness determination. If the content provider is trustworthy, the cloud connector forwards the DNS response to the client computer. The client computer then sends a content request to the content provider and receives back the requested content. However, if the content provider is not trustworthy, the DNS response is modified to specify the network address of the content scanning server. As a result, the client computer sends the content request to the content scanning server which then proxies the request to the content provider. The content scanning server monitors the traffic passing back and forth between the client computer and the content provider for malware and other potential dangers.

As a result, when the content provider is trustworthy no additional resources are spent monitoring the traffic between the client computer and the content provider. However, when the content provider is not trustworthy, the traffic is intercepted and monitored by the content scanning server for potential dangers.

In one embodiment, a method comprises: a network computer receiving a domain name service (DNS) request from a client computer that specifies a uniform resource locator (URL) of a content provider server; the network computer forwarding the DNS request to a domain name server; the network computer receiving a DNS response from the domain name server that specifies a network address of the content provider server and an identifier that indicates whether the content provider server is trustworthy; in response to a determination that the identifier indicates that the content provider service is not trustworthy, the network computer modifying the DNS response to specify a second network address at which to reach a content scanning server and forwarding the modified DNS response to the client computer.

In an embodiment, the method further comprises: in response to a determination that the identifier indicates that the content provide service is trustworthy, the network computer forwarding the DNS response to the client computer.

In an embodiment, the method further comprises: in response to receiving the DNS response from the network computer, the domain name server translating the URL of the content provider server to the network device and calculating a reputation score for the content provider server; in response to a determination that the reputation score exceeds a particular threshold, the domain name server sending the DNS response with the identifier indicating that the content provider server is trustworthy; in response to a determination that the reputation score does not exceed the particular threshold, the domain name server sending the DNS response with the identifier indicating that the content provider server is not trustworthy.

In an embodiment, the domain name server implements one or more features of Domain Name System Security Extensions (DNSSEC).

In an embodiment, the method further comprises: in response to receiving a content request from the client computer, the content scanning server sending the content request to the content provider server; in response to receiving requested content from the content provider server, the content scanning server determining whether the requested content is malicious; in response to a determination that the requested content is not malicious, the content scanning server sending the requested content to the client computer.

In an embodiment, the content request is a Hypertext Transfer Protocol (HTTP) request and the requested content is received via an HTTP response.

In an embodiment, the network computer is located at an edge between an enterprise networking that includes the client computer and a service provider network that includes the domain name server, the content scanning server, and the content provider server.

In other embodiments, the invention encompasses a computer apparatus, a computer system, and a computer-readable medium configured to carry out the foregoing steps.

2. Example Operating Environment and Process Flow

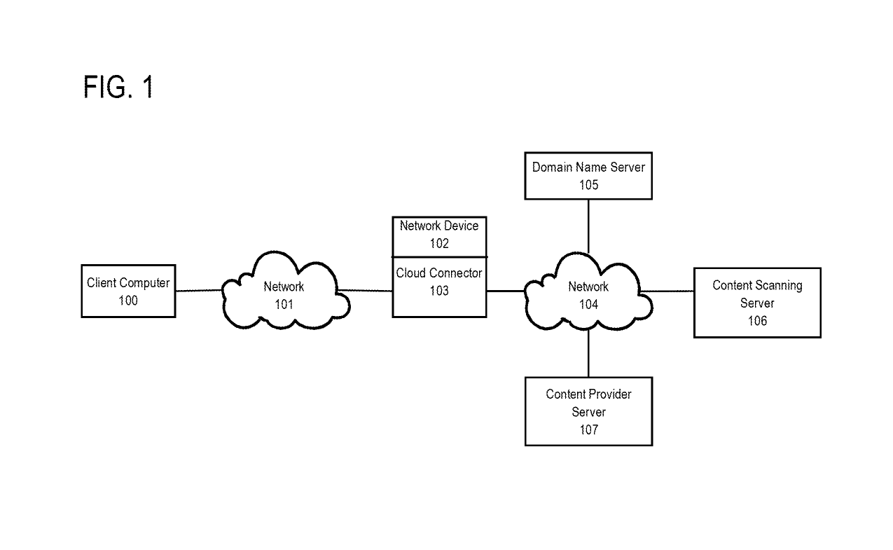

FIG. 1 illustrates an example operating environment upon which an embodiment may be implemented. In FIG. 1, a client computer 100 is communicatively coupled to network device 102 via network 101. The network device 102 is communicatively coupled to a domain name server 105, a content scanning server 106, and a content provider server 107 over network 104. In addition, the network device 102 includes a cloud connector 103 component. Although FIG. 1 only depicts a particular number of each element, a practical environment may contain hundreds, thousands, or more of each depicted element. Furthermore, in other embodiments, the depicted elements may be rearranged, divided, or combined to form different elements than those depicted in FIG. 1. For example, the cloud connector 103 may be implemented on the client computer 100, rather than the network device 102.

In an embodiment, the client computer 100 represents one or more computing devices, such as personal computers, workstations, laptops, netbooks, tablet computers, game consoles, set-top boxes, digital video recorders, smartphones, and so forth. The client computer 100 is configured to retrieve content from the content provider server 107. The exact technique used by the client computer 100 to receive the content from the content provider server 107 is not critical to the techniques described herein. However, to illustrate clear examples, it will be assumed that client computer 100 is configured to receive a uniform resource locator (URL) as input and then retrieve content from the specified URL. For example, the client computer 100 may execute a web-browser configured to display a user interface for receiving the URL and presenting the retrieved content. Thus, it will be assumed that the client computer 100 retrieves content from the content provider server 107 in two stages. In the first stage, the client computer 100 sends a DNS request that specifies the URL in order to obtain a DNS response containing the network address of the content provider server 107. In the second stage, the client computer 100 sends a content request to the content provider server 107 using the resolved address. For example, in the web-browser scenario, the content request may be a Hypertext Transfer Protocol (HTTP) request.

In an embodiment, the content provider server 107 represents one or more computing devices and/or software components that provide content to requesting clients. For example, the content provider server 107 may represent a web server, a streaming video server, a video game server, an internet radio server, and so forth. The exact type of content that the content provider server 107 provides is not critical to the techniques described herein.

In an embodiment, network 101 and network 104 represent any combination of one or more local networks, wide area networks, or internetworks. Data exchanged over the networks may be transferred using any number of network layer protocols, such as Internet Protocol (IP), Multiprotocol Label Switching (MPLS), Asynchronous Transfer Mode (ATM), and Frame Relay. Furthermore, in embodiments where the networks represent a combination of multiple sub-networks, different network layer protocols may be used at each of the underlying sub-networks. In some embodiments, network 101 represents an enterprise network and network 104 represents a service provider network. For example, network 101 may represent a customer network or virtual private network managed by a particular individual, organization, business, group, and so forth. In addition, network 104 may represent a network managed by one or more telecommunication service providers. However, the exact ownership and breakdown of responsibilities between network 101 and network 104 is not critical to the techniques described herein.

In an embodiment network device 102 represents an inter-networking device, such as a router or switch. In some embodiments, the network device 102 is an edge networking device, such as a gateway, that bridges network 101 and network 104. For example, network device 102 may represent the demarcation between an enterprise network and a service provider network. In some embodiments, the network device 102 is configured to translate between the addressing techniques and network protocols used to locate and transfer data between the nodes of network 101 and network 104.

In an embodiment, the network device 102 includes a cloud connector 103 that represents one or more software and/or hardware components that act as a broker between the client computer 100, the domain name server 105, and the content scanning server 106. In an embodiment, the cloud connector 103 is responsible for redirecting DNS requests to the domain name server 105 and redirecting content requests involving suspicious sites to the content scanning server 106.

In an embodiment, the cloud connector 103 is configured to send DNS requests from the client computer 100 to the domain name server 105 for address resolution. For example, the cloud connector 103 may be configured as a recursive DNS server that redirects DNS requests to the domain name server 105. The client computer 100 may be preconfigured or manually configured to use the cloud connector 103 as the default destination to send DNS requests. Alternatively, the cloud connector 103 may automatically update the client computer 100 to use the cloud connector 103 for address resolution. In other embodiments, the client computer 100 may be configured to send DNS requests to the domain name server 105, with the cloud connector 103 acting as an intermediary due to the network device 102 being a hop along the routing path between the client computer 100 and the domain name server 105. In still other embodiments, the client computer 100 is configured to send DNS requests to a DNS server other than domain name server 105 (not depicted) in network 104, with the cloud connector 103 intercepting and redirecting the DNS requests to the domain name server 105.

In an embodiment, the domain name server 105 represents one or more computing devices configured to provide security-enhanced DNS services. For example, communications between the domain name server 105 and the cloud connector 103 (or other components) may be encrypted to prevent man in the middle attacks. As another example, the domain name server 105 may implement one or more of the features described in the Domain Name Service Security Extensions (DNSSEC) specification, “DNS Security Introduction and Requirements” (RFC 4033) authored by Arends et al. As yet another example, the domain name server 105 may utilize OpenDNS. However, the exact security features implemented by the domain name server 105 are not critical to the techniques described herein. In other embodiments, the domain name server 105 may not implement any security-enhanced features and instead provide traditional DNS functionality.

In an embodiment, the domain name server 105 implements a reputation system which, for a given URL, provides a score indicating the trustworthiness of the corresponding content provider. For example, the domain name server 105 may implement a reputation system, such as the systems described in U.S. Pat. No. 7,756,930 by Brahms et. al, filed May 28, 2008 and U.S. Patent Pub. No. 2008-0082662A1 by Dandliker et. al, filed May 15, 2007, both of which are incorporated by reference for all purposes as though fully stated herein. However, in other embodiments, the reputation system may be implemented by a separate server which is utilized by the domain name server 105 to obtain the reputation score for a given content provider.

When the reputation score is above a particular threshold, the domain name server 105 returns the DNS response to the cloud connector 103 with an indicator specifying that the end target is “safe”. Otherwise, domain name server returns the DNS response with an indicator specifying that the end target is “suspicious”. However, in other embodiments, the domain name server 105 can instead send a numerical measure of trustworthiness with the DNS response and rely on the cloud connector 103 to determine whether the end target is “safe” (content scanning is not required) or “suspicious” (content scanning is required). Furthermore, other embodiments may utilize more than two categorizations of content providers. For example, the domain name server 105 may determine whether the target site is “safe”, “suspicious”, or “blacklisted”. When the target content provider is “blacklisted”, the cloud connector 103 prevents access to the site entirely.

In response to receiving the DNS request forwarded by the cloud connector 103, the domain name server 105 performs a DNS lookup to translate the specified URL into a corresponding network address of the content provider server 107. In addition, the domain name server 105 determines a reputation for the content provider server 107. The domain name server 105 then sends a DNS response that includes the network address and determined status back to the cloud connector 103. For example, the mechanisms described in “Extension Mechanisms for DNS (ENDS(0))” (RFC 6891) by Damas et al. may be used to include the determined status with the DNS response. However, in other embodiments, the domain name server 105 may send the reputation score in a message that is separate from the DNS response. For example, the domain name server 105 may use Representational State Transfer protocol (REST) to communicate “out-of-band” messages.

In an embodiment, the cloud connector 103, in response to receiving the DNS response from the domain name server 105, determines whether the domain name server 105 has indicated that the content provider server 107 is trustworthy. For example, the cloud connector 103 may inspect the DNS response for a flag or other identifier that indicates whether the content provider server 107 is “safe” or “suspicious” As another example, the indication may be sent to the cloud connector 103 via an out-of-band communication with the domain name server 105.

If the cloud connector 103 determines that the content provider server 107 is safe, the cloud connector 103 forwards the DNS response to the client computer 100. The client computer then generates a content request and sends the content request to the address of the content provider server 107 specified by the DNS response. Upon receiving the content request, the content provider server 107 responds with the requested content. For example, the client computer 100 may generate a HTTP request that is sent the content provider server 107. The content provider server 107 then responds with a HTTP response with the requested content and/or additional locations to obtain the requested content.

If the cloud connector 103 determines that the content provider server 107 is suspicious, the cloud connector 103 modifies the DNS response to specify the address of the content scanning server 106 instead of the content provider server 107. As a result, the client computer 100 generates a content request that is forwarded to the content scanning server 106. In an embodiment, the content scanning server 106 is a proxy server that acts as an intermediary between the client computer 100 and the content provider server 107. In addition, the content scanning server 106 inspects the forwarded traffic and determines whether the traffic is dangerous. For example, the content scanning server 106 may scan the inspected traffic for signs of exploits, viruses, trojans, and other potential dangers to the client computer 100. In some embodiments, the content scanning server 106 utilizes Cisco ScanSafe Web Security, a commercially available product by Cisco Systems Inc. that scans traffic for malware and other dangerous web traffic. If content scanning server 106 determines that the requested content from the content provider server 107 is dangerous, the content scanning server 106 blocks the content from reaching the client computer 100. For example, assuming the content is a web page, the content scanning server 106 may return a web page that explains why the requested site is blocked, rather than the content returned by the content provider server 107. Otherwise, the content scanning server 106 forwards content requests and responses between the client computer 100 and the content provider server 107. In some embodiments, the content request includes information that identifies the content provider server 107 so that the content scanning server 106 can determine where to forward the request. For example, HTTP requests typically include the URL of the requested resource. However, in other embodiments, the content request may not include information that identifies the content provider server 107. In such embodiments, the cloud connector 103 stores the network address and/or URL of the content provider server 107 and sends that information in an out-of-band message to the content scanning server 106.

In some embodiments, the cloud connector 103 caches the network address and content provider classifications received from the domain name server 105. For example, the cloud connector 103 may implement a policy that stores the DNS responses from the domain name server 105 for a particular period of time. Thus, if a DNS request is received that specifies the URL of the content provider server 107 while the corresponding cache entry is still valid, the cloud connector 103 generates and returns a DNS response to the client without contacting the domain name server 105. However, if the cached response is expired or not available, the cloud connector 103 contacts the domain name server 105 to resolve the URL into a network address as described above.

3. Suspicious Content Provider Flow Overview

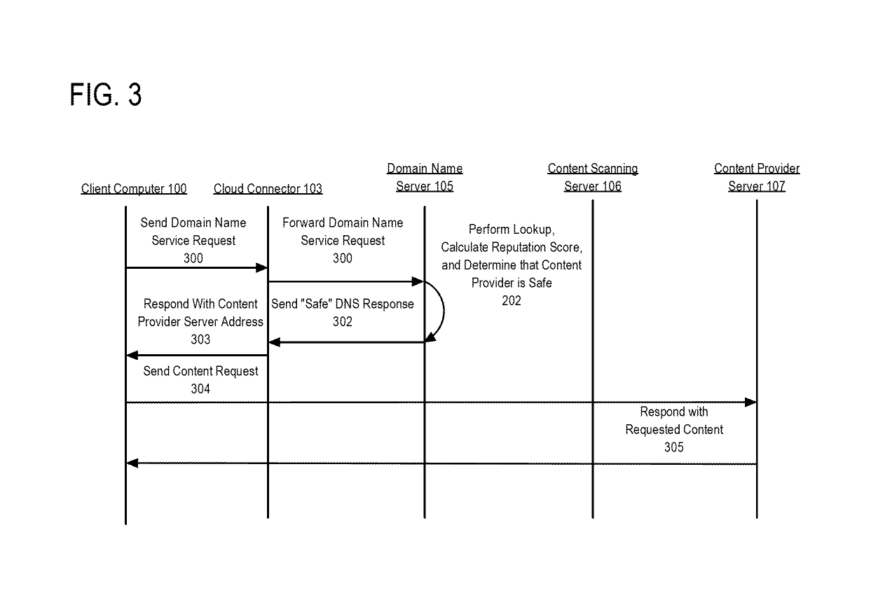

FIG. 3 illustrates an example message flow for bypassing a content scanning service for safe traffic according to an embodiment.

At step 200, the client computer 100 sends a DNS request to the cloud connector 103 that specifies a URL of the content provider server 107.

At step 201, the cloud connector 103 receives the DNS request and forwards the DNS request to the domain name server 105.

At step 202, the domain name server 105 calculates the reputation score for the content provider server 107 and determines that the content provider server 107 is suspicious. For example, the content provider server 107 may determine that the reputation score falls below a particular threshold. In addition, the domain name server performs a DNS lookup to determine the network address of the content provider server 107.

At step 203, the domain name server 105 sends a DNS response to the cloud connector 103 that specifies the network address of the content provider server 107 and that the content provider server 107 is suspicious. For example, the domain name server 105 may include a flag in the DNS response that specifies that the content provider server 107 is suspicious. However, in other embodiments, the domain name server 105 may send an additional out-of-band message that informs the cloud connector 103 that the content provider server 107 is suspicious.

At step 204, the cloud connector 103 determines that the content provider server 107 is suspicious based on the DNS response received from the domain name server 105. In response, the cloud connector 103 modifies the DNS response to specify the network address of the content scanning server 106 and sends the DNS response to the client computer 100.

At step 205, the client computer 100 generates a content request and sends the content request to the content scanning server 106 whose address is specified in the received DNS response.

At step 206, the content scanning server 106 forwards the content request to the content provider server 107. In an embodiment, the content scanning server 106 proxies the content request by modifying the source address of the message to appear as though originating from the content scanning server 106. Thus, when the content provider server 107 responds to the content request at step 207, the content provider server 107 sends the requested content to the content scanning server 106, rather than the client computer 100.

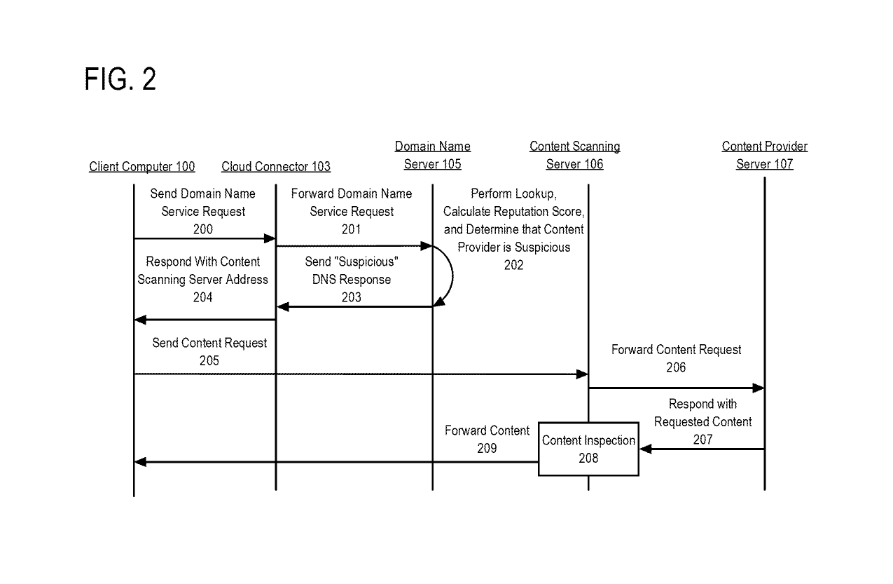

At step 208, the content scanning server 106 inspects the content to determine whether the response contains malware or other potential dangers for the client computer 100. If the content scanning server 106 determines that the response contains malicious material, the content scanning server 106 blocks the content from being returned to the client computer 100. In some embodiments, the content scanning server 106 replaces the content with “error” content that informs when displayed by the client computer 100, informs a user that the requested content has been determined to be malicious and will therefore not be made available. Otherwise, at step 209, the content scanning server 106 forwards the requested content to the client computer 100. Although the content scanning server 106 is depicted in FIG. 2 as only inspecting the content returned from the content provider server 107 at step 208, the content scanning server 106 may also scan subsequent content requests from the client computer 100 in the same manner. In addition, in some embodiments, the content scanning server 106 also scans the content request to potentially cut off requests for content that the content scanning server 106 can determine is malicious without needing to actually retrieve the content for scanning. Thus, some embodiments may include an additional scanning step between step 205 and step 206.

4. Safe Content Provider Flow Overview

FIG. 3 illustrates an example message flow for bypassing a content scanning service for safe traffic according to an embodiment.

At step 300, the client computer 100 sends a DNS request to the cloud connector 103 that specifies a URL of the content provider server 107.

At step 301, the cloud connector 103 receives the DNS request and forwards the DNS request to the domain name server 105.

At step 302, the domain name server 105 calculates the reputation score for the content provider server 107 and determines that the content provider server 107 is safe. For example, the content provider server 107 may determine that the reputation score is at or above a particular threshold. In addition, the domain name server performs a DNS lookup to determine the network address of the content provider server 107.

At step 303, the domain name server 105 sends a DNS response to the cloud connector 103 that specifies the network address of the content provider server 107 and that the content provider server 107 is safe. For example, the domain name server 105 may include a flag in the DNS response that specifies that the content provider server 107 is safe. However, in other embodiments, the domain name server 105 may send an additional out-of-band message that specifies that the content provider server 107 is safe.

At step 304, the cloud connector 103 determines that the content provider server 107 is safe based on the DNS response received from the domain name server 105. In response, the cloud connector 103 forwards the DNS response to the client computer 100. As a result, the cloud connector at step 305 generates a content request and sends the content request to the content provider server 107 whose network address is specified by the received DNS response.

At step 306, the content provider server 107 returns the requested content to the client computer 100.

3. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A data processing method comprising:
a network computer receiving a domain name service (DNS) request from a client computer that specifies a uniform resource locator (URL) of a content provider server;
the network computer forwarding the DNS request to a domain name server;
the network computer receiving a DNS response from the domain name server that specifies a network address of the content provider server and an identifier that indicates whether the content provider server is trustworthy;
in response to a determination that the identifier indicates that the content provider service is not trustworthy, the network computer modifying the DNS response to specify a second network address at which to reach a content scanning server and forwarding the modified DNS response to the client computer.

2. The method of claim 1, further comprising:
in response to a determination that the identifier indicates that the content provide service is trustworthy, the network computer forwarding the DNS response to the client computer.

3. The method of claim 1, further comprising:
in response to receiving the DNS response from the network computer, the domain name server translating the URL of the content provider server to the network device and calculating a reputation score for the content provider server;
in response to a determination that the reputation score exceeds a particular threshold, the domain name server sending the DNS response with the identifier indicating that the content provider server is trustworthy;
in response to a determination that the reputation score does not exceed the particular threshold, the domain name server sending the DNS response with the identifier indicating that the content provider server is not trustworthy.

4. The method of claim 1, wherein the domain name server implements one or more features of Domain Name System Security Extensions (DNSSEC).

5. The method of claim 1, further comprising:
in response to receiving a content request from the client computer, the content scanning server sending the content request to the content provider server;
in response to receiving requested content from the content provider server, the content scanning server determining whether the requested content is malicious;
in response to a determination that the requested content is not malicious, the content scanning server sending the requested content to the client computer.

6. The method of claim 5, wherein the content request is a Hypertext Transfer Protocol (HTTP) request and the requested content is received via an HTTP response.

7. The method of claim 1, wherein the network computer is located at an edge between an enterprise networking that includes the client computer and a service provider network that includes the domain name server, the content scanning server, and the content provider server.

8. A non-transitory computer-readable medium storing one or more instructions which, when executed by one or more processors, cause the one or more processors to perform steps comprising:
a network computer receiving a domain name service (DNS) request from a client computer that specifies a uniform resource locator (URL) of a content provider server;
the network computer forwarding the DNS request to a domain name server;
the network computer receiving a DNS response from the domain name server that specifies a network address of the content provider server and an identifier that indicates whether the content provider server is trustworthy;
in response to a determination that the identifier indicates that the content provider service is not trustworthy, the network computer modifying the DNS response to specify a second network address at which to reach a content scanning server and forwarding the modified DNS response to the client computer.

9. The non-transitory computer-readable medium of claim 8, wherein the steps further comprise:
in response to a determination that the identifier indicates that the content provide service is trustworthy, the network computer forwarding the DNS response to the client computer.

10. The non-transitory computer-readable medium of claim 8, wherein the steps further comprise:
in response to receiving the DNS response from the network computer, the domain name server translating the URL of the content provider server to the network device and calculating a reputation score for the content provider server;
in response to a determination that the reputation score exceeds a particular threshold, the domain name server sending the DNS response with the identifier indicating that the content provider server is trustworthy;
in response to a determination that the reputation score does not exceed the particular threshold, the domain name server sending the DNS response with the identifier indicating that the content provider server is not trustworthy.

11. The non-transitory computer-readable medium of claim 8, wherein the domain name server implements one or more features of Domain Name System Security Extensions (DNSSEC).

12. The non-transitory computer-readable medium of claim 8, wherein the steps further comprise:
in response to receiving a content request from the client computer, the content scanning server sending the content request to the content provider server;
in response to receiving requested content from the content provider server, the content scanning server determining whether the requested content is malicious;
in response to a determination that the requested content is not malicious, the content scanning server sending the requested content to the client computer.

13. The non-transitory computer-readable medium of claim 12, wherein the content request is a Hypertext Transfer Protocol (HTTP) request and the requested content is received via an HTTP response.

14. The non-transitory computer-readable medium of claim 8, wherein the network computer is located at an edge between an enterprise networking that includes the client computer and a service provider network that includes the domain name server, the content scanning server, and the content provider server.

15. A network device comprising:
one or more processors;
one or more network interfaces;
one or more non-transitory computer-readable storage media storing one or more instructions which, when executed by the one or more processors, cause performing:
the network computer receiving a domain name service (DNS) request from a client computer that specifies a uniform resource locator (URL) of a content provider server;
the network computer forwarding the DNS request to a domain name server;
the network computer receiving a DNS response from the domain name server that specifies a network address of the content provider server and an identifier that indicates whether the content provider server is trustworthy;
in response to a determination that the identifier indicates that the content provider service is not trustworthy, the network computer modifying the DNS response to specify a second network address at which to reach a content scanning server and forwarding the modified DNS response to the client computer.

16. The network device of claim 15, wherein the one or more instructions, when executed by the one or more processors, further cause performing:
in response to a determination that the identifier indicates that the content provide service is trustworthy, the network computer forwarding the DNS response to the client computer.

17. The network device of claim 15, wherein
the domain name server is configured to, in response to receiving the DNS response from the network computer, translate the URL of the content provider server to the network device and calculate a reputation score for the content provider server,
the domain name server is configured to, in response to a determination that the reputation score exceeds a particular threshold, send the DNS response with the identifier indicating that the content provider server is trustworthy;
the domain name server is configured to, in response to a determination that the reputation score does not exceed the particular threshold, send the DNS response with the identifier indicating that the content provider server is not trustworthy.

18. The network device of claim 15, wherein the domain name server implements one or more features of Domain Name System Security Extensions (DNSSEC).

19. The network device of claim 15, wherein:
the content scanning server is configured to, in response to receiving a content request from the client computer, send the content request to the content provider server,
the content scanning server is configured to, in response to receiving requested content from the content provider server, determine whether the requested content is malicious,
the content scanning server is configured to, in response to a determination that the requested content is not malicious, send the requested content to the client computer.

20. The network device of claim 19, wherein the content request is a Hypertext Transfer Protocol (HTTP) request and the requested content is received via an HTTP response.

21. The network device of claim 15, wherein the network computer is located at an edge between an enterprise networking that includes the client computer and a service provider network that includes the domain name server, the content scanning server, and the content provider server.
